(19) United States
(12) Patent Application Publication
(10) Pub. No.: US 2009/0148622 A1
(43) Pub. Date: Jun. 11, 2009

(54) PROCESS FOR THE REPAIR AND RESTORATION OF DYNAMICALLY STRESSED COMPONENTS COMPRISING ALUMINIUM ALLOYS FOR AIRCRAFT APPLICATIONS

(76) Inventors: Thorsten Stoltenhoff, Ennepetal (DE); Folker Zimmermann, Wollstein (DE); Klaus Gorris, Bottrop (DE); Hans Burger, Erzhausen (DE)

Correspondence Address: PRAXAIR, INC.;LAW DEPARTMENT - M1 557, 39 OLD RIDGEBURY ROAD, DANBURY, CT, 06810-5113, US

(21) Appl. No.: 12/280,868

(22) PCT Filed: Feb. 22, 2007
(86) PCT No.: PCT/EP2007/001552

§ 371 Date: Jan. 2, 2009

(30) Foreign Application Priority Data
Mar. 2, 2006 (EP) 06004229.8

(51) Int. Cl. B05D 3/00; C23C 28/00

(52) U.S. Cl. 427/554; 427/142; 427/8; 205/188

(57) ABSTRACT

The present invention relates to a process for the repair and restoration of dynamically stressed components comprising aluminium alloys for aircraft applications in which (a) the base material from which the component to be repaired was manufactured is determined, (b) the component to be repaired is, if necessary, subjected to pre-treatment, (c) a spray material which has chemical, physical and mechanical properties comparable to those of the base material is selected, (d) coating parameters for the subsequent coating process are selected so that bonding within the layer to be applied is optimized, (e) the spray material is applied to the component to be repaired by means of cold gas spraying in order to replace material which has been removed by wear and pre-treatment, and (f) the coated component is after-treated in such a way that the original component geometry is restored. This process allows components for use in aircraft to be restored without additional process steps, in particular thermal process steps such as sintering, being necessary for this purpose.

The invention relates to a process for the repair and restoration of dynamically stressed components comprising aluminium alloys for aircraft applications.

Components used in aerospace applications always are subject to the demand for weight optimization; because of the loads occurring in flying operations simultaneously there are extremely high material requirements as to mechanical, physical and chemical characteristics, in order to ensure the operational safety of the aircraft. These partly contradictory requirements for example are reflected in very filigrained structures and complex shapes, but also in the selection of the materials, whereby, to name only some, e.g. a particularly high degree of torsion resistance, vibratory resistance or corrosion resistance is to be attained. Therefore high-strength aluminium alloys represent one of the most important groups of materials for aviation and space operations. The particularly favorable relationship of physical density to strength—particularly under vibratory stress—in connection with the relatively modest sensitivity against alternating temperature stress, predetermines these materials for use in the field of the landing gear or also the driving gear of the structure.

The progressing technical advance in aviation and space operations and the increasing demands on material and structure of components resulting therefrom, against the background of constantly increasing cost pressure, make an economical restoration of the mostly very expensive components unpronounceable today. However, the restoration process is considerably impeded by the aforementioned characteristics of aeronautical components, such as complexity, selection of material and borderline design, because of the requirements of accuracy of shape and the fact that e.g. detrimental influences on the base material must be avoided. Inappropriate handling during the process of manufacturing/repair already can lead to mechanical damages, wherein excessive supply of heat in the course of the treatment process can result in significant loss of strength.

Components, used in the field of aviation and space operations, such as e.g. landing gear components and propeller blades, sometimes are subjected during operation to extraordinary stress.

Thus e.g. landing gears of aircrafts experience substantially two main types of stress, a mechanical component during take off and landing and a continuous corrosion attack due to environmental influences. The mechanical load in turn comprises the static load caused by the weight of the aircraft, short-time bending load during towing of the aircraft and heavy dynamic load during take off and landing. As to the dynamic load during take off and landing it is appropriate to make a further distinction between aircrafts which require for the take off and landing operation a path for acceleration/deceleration (normal aircrafts), and aircrafts which at first take off from ground in vertical direction, without take off/landing runway, before acceleration in headway direction takes place (helicopters and vertical take-off planes). In the case of normal aircrafts an extreme load is acting on the landing gear because of the required high take-off speeds in connection with the comparably high take-off weights. During landing the deceleration of the brake additionally causes a bending load. In both types of operation unevenness of the take off and landing runway is transferred which in spite of dampening by tyres and springs is acting on the landing gear structure and e.g. causes vibrations there. Such vibrations not only favour the generation and spreading of cracks but also of wear on components moving relative to each other, such as landing gear cylinders and pistons. Helicopters and vertical take-off planes need not move long distances on the runway for take off and landing, whereby the load is distinctly decreased; never the less here, too, the relative movement between moving parts results in vibrations which are transferred from the driving gear to the entire structure, and in wear of similar extent. Due to local wear—e.g. in the region of sealing rings—gaps are formed, impurities, such as dust of the surrounding air, penetrate and intensify the wear mechanism on mowed parts.

Splash water, which under winter operational conditions additionally is mixed with solved salts, and condensed water formed as a function of flight altitude and humidity of the air, offer the base for the occurrence of corrosion attack. In spite of the comparably very good self-protection of aluminium by the rapidly forming stable oxide layer, the corrosion attack occurs particularly markedly in the vicinity of weak points such as screw connections and sealings, because they mostly offer a certain access for any electrolytes and because a sealing or a sealing seat, upon once being damaged, scarcely still offers an effective protection. Furthermore it is known that the dynamic load of a component favours corrosion, particularly types as pitting or stress crack corrosion.

Extreme dynamic loads also particularly occur at propeller blades. The task of propellers is to deliver the rotational energy generated by a motor to the surrounding medium in the form of flow energy. Their functioning is based on the principle that a certain mass of air per time unit is caught by the rotation and is accelerated and repelled from its rest position in rearward direction. The different curvatures of the upper and lower sides and the orientation of the individual blades provide for a different extent of deflection and acceleration of the surrounding medium, e.g. air. Suction is generated at the more extensively curved side because the medium here has to cover a longer path and correspondingly is accelerated to higher speeds; this side (facing the direction of movement) therefore also being called the suction side. In a corresponding manner the side of lower flow speeds and higher pressure is called pressure side (averted from the direction of movement). The pressure gradient between the suction and pressure sides generates at each blade dynamic lifting forces the axially directed components of which together are driving the propeller and the object connected thereto in forward direction. The superimposed axial forces also are called thrust. The higher flow speeds of the air at the suction side of the propeller blade likewise generate higher speeds of the solid and liquid materials contained therein, such as dust, sand and smaller stones or also water droplets. The impact thereof on the blade surface results in heavy plastic deformations (crater formation) and in marked erosion of material particularly in the vicinity of the front edge of the propeller blade. Heavy local damages caused e.g. by whirled up material during the take-off/landing phase of the aircraft may act just in these dynamically highly loaded components as a notch for crack spreading and may cause sudden failure. Further parameters influencing the erosion of material are the operational conditions and in connection therewith the incidence of the blade and the place of operation. The extreme dynamic load and the continuously occurring wear by erosion most frequently are superimposed by corrosion attack which likewise depends on the conditions of operation, e.g. operation under winter or tropic conditions.

The mechanics of fluids of a propeller blade determine the amount of thrust of the drive gear. Thrust is generated by the acceleration of a mass; therefore deviations from the designed blade geometry are tolerable to only a very limited extent. Therefore it will be profoundly examined in the course of blade reconditioning to what extent the actual geometry of the blade differs from the desired value and what losses of thrust are connected therewith. Blades for which the geometry with its minimum dimensions no longer could be adjusted therefore had to be scraped up to now.

In the course of reconditioning landing gear components it will be profoundly examined how far the damages by corrosion and mechanic wear have developed and whether there is a danger of failure of the component in further use. So far repair measures were possible to a very limited extent only and were substantially reduced to smoothing of sealing seats, guide elements and the like by grinding and polishing, followed by a restoration of the protection against corrosion, e.g. by anodizing or chromating.

Whereas coatings applied in flat-spread manner by thermal spraying (high-speed flame spraying, plasma spraying, arc spraying, detonation gun spraying) in numerous applications considerably help to prolong the life time of components, these processes can be applied to a limited extent only for components which are used in aviation and in space technology. Thus these processes have only limited applicability particularly in view of limited layer thickness and problems of adherence on aluminium alloys.

In thermal spraying processes the spray material is supplied as powder or wire to an energy source, and there it is molten or melting thereof is started. The name of the spraying procedure depends on the process by which the thermal energy for melting the spray materials is generated. In the established processes this is done by combusting a mixture of fuel and oxygen, starting an arc, or bringing a process gas into a plasma-type condition. The molten material then is accelerated towards the surface of the component by the expanding combustion gases or also by pressurized air.

Layers produced with thermal spraying processes contain oxides and pores which can affect the characteristics of the layers to a varying extent. In the case of corrosion-protection layers of aluminium and zinc on steel for example, the influence is mall because these layers are less noble than steel and the protective action therefore is existent until the anodicly acting layer has disintegrated. Different therefrom, cathodicly acting layers, e.g. layers of nickel alloys on steel, must be dense in order to prevent any contact between the base material and the corrosive medium. They also must not contain any oxides at the interfaces which contain particles which in the case of the corrosion dissolve away and allow penetration of the medium down to the base material. Physical characteristics, such as the electrical conductivity or the thermal conductivity, likewise are impaired by oxides and pores.

Furthermore, repair processes requiring melting of the repair material or even of the base materials, such as thermal spraying processes (high-speed flame spraying, plasma spraying, arc spraying, detonation gun spraying), can be applied to a limited extent only for reasons of design and manufacturing, because, dependent on the shape of the component and the history of the manufactory thereof, the required heat input frequently is accompanied by an inadmissible distortion. The disadvantageous effects resulting from the selection of the material used are of particular importance because direct recognition thereof is not always possible, so that these effects represent a particular potential for hazards as to the safety of operation. Thus thermally activated processes, such as phase conversions, alloy formation and particle growth, can lead to unforeseeable changes of the characteristics of the material, e.g. loss of strength and thus failure of the entire component. Furthermore many materials used in aviation can not be welded or welded only with great expenditure, and such welds always are accompanied by influences on the conditions of structure and stress.

The mechanical properties of the layers are impaired, however, in a particularly disadvantageous manner. Thus it is well known that thermally sprayed layers, in comparison with bulk material, have only a very low fatigue strength under oscillating stress.

Further developments of thermal spraying processes therefore aimed at a reduction of the oxide content and of the proportion of pores of the layers. A big advance was the introduction of the vacuum plasma spraying and of the low pressure plasma spraying which allowed the production of layers lean of oxides even from very reactive materials. In the field of aviation and power station technology e.g. dynamically and thermally highly stressed turbine blades are coated with MCrAlY-alloys (M for Ni and/or Co) for protection against oxidation.

The cold gas spraying described e.g. in U.S. Pat. No. 5,302,414 and EP 0 484 533 represents an important advance in the field of surface technology in that it allows the production of particularly dense layers lean of oxides even under atmospheric conditions. Though the mechanophysical key properties of the layers, such as ductility, vibratory resistance and ductility, are particularly favoured in this process, cold gas spraying was applied in coating dynamically highly stressed components, such as turbine blades, merely in connection with a subsequent thermal treatment of the coated components. Thus, U.S. Pat. No. 6,905,728 describes the application of cold gas spraying for the repair and the restoration of the geometry of high-pressure components in the field of stationary gas turbines, turbo-engines and auxiliary driving gears. An essential part of the method explained there is a thermal treatment of the component e.g. by sintering, following coating by cold gas spraying. This post-treatment is a prerequisite for obtaining the requested mechanical and physical properties of the layer.

In fact, heterogeneous structural conditions and distributions of characteristics in some case basically could be homogenized by thermal treatments; these, however are not admissible because of the type of production of many components,—e.g. by forging processes—or are impossible or possible only with high expenditure in view of the dimensions of the components. The temperature sensitivity of the structure can be explained particularly well with reference to hardenable aluminium alloys. Thus, in the case of the alloy AA2224 the aging process—i.e. a significant growth of the precipitation particles—already starts at about 190°. In the case of the alloy AA7075 this process even already starts at 120° C.

As a consequence of the above explained problems so far dynamically stressed components for aircraft applications, in which the wear had reached such a high degree, that the required mechanical stability no longer is obtained, were completely replaced at high costs.

The object basic to the subject invention is to provide for a process for the repair and restoration of dynamically stressed components comprising aluminium alloys for aircraft applications, which process permits the restoration also of components the repair of which with customary processes so far was technically impossible or economically did not make sense.

This object is reached in conformity with the invention by a process for the repair and restoration of dynamically stressed components comprising aluminium alloys for aircraft applications as defined in claim 1.

In the course of this process
a. the base material from which the component to be repaired was manufactured is determined,
b. the component to be repaired is, if necessary, subjected to pre-treatment,
c. a spray material which has chemical, physical and mechanical properties comparable to those of the base material is selected,
d. coating parameters for the subsequent coating process are selected so that bonding within the layer to be applied is optimized,
e. the spray material is applied to the component to be repaired by means of cold gas spraying in order to replace material which has been removed by wear and pre-treatment, and
f. the coated component is after-treated in such a way that the original component geometry is restored.

This process offers the particular advantage that also components which so far had to be replaced, may be restored for use in an aircraft. Thus, e.g. also propeller blades in which so far grinding-in of a contour having an admissible dimensional error no longer was possible or was falling short, may be restored for use in an aircraft. The necessary material characteristics are attained by the presently proposed process particularly with regard to vibrational fatigue strength, without additional process steps, such as sintering, being required.

In conformity with the invention this is attained by tailoring the spray material to the base material to be coated as to its chemical composition as well as by adjusting the coating parameters, such as e.g. the distribution of the powder particle size, the process parameters, the nozzle geometry and the like such that optimum bonding within the layer is obtained. Preferably, the fatigue strength of the layer as determined in vibrational stress tests is used as characterization of the quality of bonding. The layers produced in this manner demonstrably reach the fatigue strength of the base material.

Preferred embodiments of the invention are indicated in the subclaims.

Preferably, in a purifying step, the component to be repaired is relieved of protective coats of lacquer and soluble impurities by purification processes. Particularly, when the component to be repaired is a propeller blade, a granulated cured urea formaldehyde resin may be used for this purpose; with the aid of this resin soluble impurities as well as lacquering and/or washing primer residuals are completely removed from the component to be repaired. Here, in contrast to chemical lacquer stripping, besides of aluminium, no fractions of oxygen, zinc, phosphorus and chromium can be detected

Preferably, worn and/or corroded areas are removed to such an extent that traces of wear and corrosion no longer are visible. Mechanical treatment process, such as e.g. milling, turning or drilling, electric discharge machining, electrochemical processes or evaporation, may be used for this removal of material. In a preferred manner, machining is effected merely locally in the area of the respective wear or corrosion by cutting processes, such as turning or milling; most preferably the machining is done by grinding. When the presently suggested process is used for the repair of a propeller blade, the material from the worn and/or corroded areas preferably is effected to a depth from 0.1 to 0.8 mm. However, the removal of material also may be executed in such a manner that a minimum thickness of residual material as required by the respective design is ensured, that however external damages remain visible. For this purpose the worn and/or corroded areas are removed to a depth of preferably 0.1 to 0.5 mm.

The material removed by wear and machining again is applied by means of cold gas spraying preferably of a material having the same or a similar composition and the same or similar chemical, physical and mechanical characteristics. In doing so, the thickness of the sprayed layer at least reaches a value corresponding to that of the largest depth of wear at the respective functional area plus an oversize for the subsequent machining. In a preferred manner, the layer is applied with the same thickness to the entire functional area. In a particularly preferred embodiment, the thickness of the layer is adapted to the locally varying depth of wear.

In contrast to other coating applications an activation of the surface of the component by corundum blasting usually is not admissible in the case of dynamically stressed aircraft components made of aluminium alloys because it can not be excluded that sharp-edged corundum particles cause damages in the substrate surface or remain adhering there as an inclusion thus acting as a germ for later crack propagation.

In the course of the coating process the powder particles are continuously injected within a spray gun into a compressed gas that is heated without combustion. By subsequent depressurization of the gas/particle mixture in a de Laval nozzle, this mixture, dependent on the type of gas and the nozzle geometry, sometimes reaches a multiple of sonic speed. The powder particles in turn reach such high velocities that alone the conversion of kinetic energy into heat and work of deformation is sufficient to cause an adherence at the instant of hitting the component to be coated. The base for this is a plastic flow of the material in the vicinity of the particle-particle/particle-substrate-interfaces as a result of the occurrence of adiabatic shear instabilities. Preheating of the gas is intended to increase the sonic speed thereof and thus also of the absolute velocity of the gas/particle-flow. Furthermore, the particles are heated already during the short stay in the hot section of the flow, whereby the deformability of the particles at impact is improved. However, the gas temperature at the place of injection always is below the melting point of the coating material, so that melting of the particles does not start or occur during the flight phase. Disadvantages such as oxidation, thermally activated phase transformations or alloy formation, known from other thermal spray processes, can be nearly completely avoided in cold gas spraying.

Subsequent to the coating step, the component to be repaired preferably is treated by mechanical machining processes, such as milling, turning or drilling, in order to restore the original geometry. In conformity with a particular embodiment, the treatment is effected by electric discharge machining, electrochemical processes or evaporation.

Upon the original geometry of the coated component having been restored, the functional areas of the component may be finished as to their shape and surface structure. Finishing of the functional areas particularly may be obtained by processes such as grinding, honing, lapping and polishing, whereby the shape and function of a new component may be attained within the tolerated limits.

In the course of grinding or smoothing of aluminium surfaces aluminium particles may be pressed into the surface. For this reason a continuous supply of fresh grinding additives and a simultaneous removal of the removed material are urgently required. Good results were obtained for example in repairing a propeller blade in that a pre-grinding was carried out with a commercially available manual grinding machine using a fiber disc and a coarse grain size (e.g. grain size 40), wherein the spray-rough surface was smoothened to 0.2 to 0.6 mm. Here, the geometry of the propeller blade preferably already was restored in the second step. The examination as to shape and geometry was carried out with predetermined shape profile templates. Then the surface was smoothened by a flap disc grinder using a grain size of 150, and subsequently finish-ground by superfinishing with a grain size of between 120 and 240 to 0.1 to 0.2 mm. Upon finishing of the profile, the surface was machined with commercial polishing discs such that a reflective surface was obtained in order to thus limit the frictional resistance of the air flow to a minimum.

The repair process may be finished by sealing the treated surfaces; for this purpose the treated surfaces may be lacquered, anodized or chromatized. Before protecting the surfaces by anodizing, however, an examination for cracks, preferably in conformity with ASTM E 1417-99, should take place, wherein Type I (fluorescent), Method A (water washable), mode a (dry powder) turned out to be of particular advantage. This non-destructive testing serves to detect irregularities such as bonding defects, cracks, overlappings and pores.

The type of process used for obtaining the anodic surface protection (anodizing) depends on the material used in the specific application. By an anodic oxidation in chromic acid or sulphuric acid the thickness of the oxide skin forming on aluminium components under atmospheric conditions is increased a thousand times, whereby not only the protection against corrosion but also the wear resistance may be substantially improved. The treatment can be used for a major part of the commercially available aluminium alloys.

The surface treatment preferably is carried out in chromic acid, producing a layer having a thickness from 1 to 5 μm, which in fact is thinner than that obtained when using sulphuric acid, which, however, has a higher elasticity. In a particularly preferred manner the thickness of the layer is adjusted to 3 to 4 μm, wherein, however, a subsequent compaction is dispensed with because a better lacquer adherence is attained on non-compacted layers.

The presently described repair processes do not require a thermal post-treatment of the coated component as discussed in U.S. Pat. No. 6,905,728 in order to attain the necessary mechanical characteristics.

In spite of the fact that the presently proposed process was described particularly in connection with the repair of propeller blades or landing gear components, it is self-evident, that this process of course likewise may be applied in the repair of other heavily dynamically stressed aircraft components.

1. Process for the repair and restoration of dynamically stressed components comprising aluminium alloys for aircraft applications, characterized in that
(a) the base material from which the component to be repaired was manufactured is determined,
(b) the component to be repaired is, if necessary, subjected to pre-treatment,
(c) a spray material which has chemical, physical and mechanical properties comparable to those of the base material is selected,
(d) coating parameters for the subsequent coating process are selected so that bonding within the layer to be applied is optimized,
(e) the spray material is applied to the component to be repaired by means of cold gas spraying in order to replace material which has been removed by wear and pre-treatment, and
(f) the coated component is after-treated in such a way that the original component geometry is restored.

2. Process as claimed in claim 1 characterized in that in the course of step (b) the component to be repaired is relieved of protective coats of lacquer and soluble impurities by purification processes.

3. Process as claimed in claim 1 characterized in that in the course of step (b) worn and/or corroded areas are removed to such an extent that traces of wear and corrosion no longer are visible.

4. Process as claimed in claim 1 characterized in that subsequent to step (f) functional areas of the component are finished as to shape and surface structure.

5. Process as claimed in claim 1 characterized in that a final sealing of the worked surfaces is carried out.

6. Process as claimed in claim 5 characterized in that the worked surfaces are lacquered, anodized or chromatized.

7. Process as claimed in claim 6 characterized in that the restored surface is anodized.

8. Process as claimed in claim 7 characterized in that anodic oxidation is carried out in chromic acid or sulfuric acid.

9. Process as claimed in claim 7 characterized in that anodic oxidation is carried out until an oxide skin having a thickness from 1 to 5 μm, preferably from 3 to 4 μm, is attained.

10. Process as claimed in claim 1 characterized in that electrochemical treatment processes, electro-discharge or laser processes are applied for pre- and/or final treatment.

11. Process as claimed in claim 1 characterized in that in the course of step (e) the material is uniformly applied onto the entire affected area at least in a thickness corresponding to the largest depth of wear on that area.

12. Process as claimed in claim 1 characterized in that in the course of step (e) the material is applied onto the affected area in a coating thickness corresponding to the locally varying depth of wear.

13. Process as claimed in claim 1 characterized in that sprayed material has substantially the same composition as the base material.

14. Process as claimed in claim 1 characterized in that sprayed material has a composition which differs from that of the base material, the sprayed material however having comparable chemical, physical and mechanical properties.

15. Process as claimed in claim 1 characterized in that prior to coating the component is not subjected to a mechanical activation, such corundum blasting.

16. Process as claimed in claim 1 characterized in that after step (f) a layer having protective functions against wear, corrosion or other detrimental influences on the component, is applied.

17. Process as claimed in claim 16 characterized in that the coating for protection against wear, corrosion or other detrimental influences is applied by thermal and electroplating coating processes.

18. Process as claimed in claim 1 characterized in that the fatigue strength of the layer as determined in vibrational stress tests is used as characterization of the quality of bonding in the course of step (d).

19. Process as claimed in claim 1 characterized in that the component to be repaired is a landing gear component.

20. Process as claimed in claim 1 characterized in that the component to be repaired is a propeller blade.

21. Process as claimed in claim 20 characterized in that a granulated cured urea formaldehyde resin is used to remove from the component to be repaired soluble impurities as well as lacquering and/or washing primer residuals in the course of step (b).

22. Process as claimed in claim 20 characterized in that worn and/or corroded areas are removed to a depth from 0.1 to 0.8 mm in the course of step (b).

23. Process as claimed in claim 21 characterized in that a major part of the suction or the pressure side, respectively, of the propeller blade is coated in the course of step (e).
